(19) United States
(12) Patent Application Publication
(10) Pub. No.: US 2011/0226086 A1
(43) Pub. Date: Sep. 22, 2011

(54) ACTUATION SYSTEM FOR A CLUTCH-BY-WIRE SYSTEM AND METHOD FOR CUSTOMIZING AN ACTUATION SYSTEM FOR A CLUTCH-BY-WIRE SYSTEM

(75) Inventor: Eckhard Kirchner, Vaesby (DE)

(73) Assignee: GM GLOBAL TECHNOLOGY OPERATIONS LLC, Detroit, MI (US)

(21) Appl. No.: 13/131,685

(22) PCT Filed: Sep. 23, 2009
(86) PCT No.: PCT/EP2009/006884

§ 371 Date: May 27, 2011

(30) Foreign Application Priority Data
Nov. 27, 2008 (GB) GB0821649.1

(51) Int. Cl. G05G 1/38; G05G 5/03; F16D 23/12; F16D 48/06

(52) U.S. Cl. 74/514; 267/166

(57) ABSTRACT

An actuation system for a clutch-by-wire system includes, but is not limited to a clutch pedal, at least one position sensor sensing the actual position of the clutch pedal and providing a position signal, and at least one spring providing a load, against which the clutch pedal is movable. The spring characteristic of the at least one spring is adjustable.

### CROSS-REFERENCE TO RELATED APPLICATIONS

This application is a U.S. National-Stage entry under 35 U.S.C. §371 based on International Application No. PCT/EP2009/006884, filed Sep. 23, 2009, which was published under PCT Article 21(2) and which claims priority to British Application No. GB0821649.1, filed Nov. 27, 2008, which are all hereby incorporated in their entirety by reference.

### TECHNICAL FIELD

The invention relates to an actuation system for a clutch-by-wire system comprising a clutch pedal, at least one position sensor sensing the actual position of the clutch pedal and providing a position signal and at least one spring providing a load, against which the clutch pedal is movable. The invention also relates to a method for customizing such an actuation system for a clutch-by-wire system.

### BACKGROUND

The document DE 10 2006 026 975 A1 describes attempts to provide a clutch-by-wire system with an actuation force characteristic which may be adjusted to individual requirements. However, no concrete technical implementation is described in this document.

It is at least one object to provide an actuation system for a clutch-by-wire system, which may be customized easily and safely either by a driver himself or by service personnel. It is a further object of the invention to provide a method for customizing an actuation system for a clutch-by-wire system.

### SUMMARY

An actuation system is provided for a clutch-by-wire system comprises a clutch pedal, at least one position sensor sensing the actual position of the clutch pedal and providing a position signal and at least one spring providing a load, against which the clutch pedal is movable. The spring characteristic is adjustable.

The force characteristic of a clutch pedal may be adjusted to customer needs by changing the spring characteristic of at least one spring of the actuation system. Typically, the actuation system comprises an over center spring and another spring, hereinafter referred to as “retention spring.” The clutch pedal is moveable against the loads of these springs by a driver. It is to be noted, that the term “moveable against a load” shall not limit the direction of the spring force. Especially in the case of the over center spring, this direction may change along the spring travel.

The term “spring characteristic” shall include for example components like the spring constant, pre-load, length and number of springs.

According to an embodiment of the invention, the spring characteristic is adjustable by exchanging the spring. In order to allow an easy exchange, the exchangeable spring may be contained in an exchangeable cartouche. This cartouche or the spring itself is accessible for the driver himself or service personnel without requiring disassembly of the actuation system.

The spring characteristic may also be adjustable by changing the spring travel. The spring travel may for example be reduced by inserting a bolting element disabling a part of the spring travel and enlarged by removing such a bolting element.

According to an embodiment of the invention, the spring characteristic is adjustable by changing the position of a pivot point of the spring. One end of the spring may for example be fixed in the pivot point by frictional locking by a screw or a wing bolt. According to one embodiment of the invention, a finite number of pivot points is provided by a perforated plate, in whose perforations the spring is fixed by a fastening element. According to another embodiment, an infinite number of pivot points is provided by at least one slot, in which the spring is fixed by a fastening element. Such a slot may be curved. Furthermore, several slots and/or holes may be provided.

Such slots provide an infinite number of pivot points, allowing the position of the pivot point to be changed continuously, while holes or a perforated plate provide a number of discrete positions for the pivot point.

The spring characteristic may also be adjustable by changing the pre-load of the spring. The pre-load may for example be changed by elongating or shortening the spring in its rest position.

According to an embodiment of the invention, the actuation system comprises at least a first spring and a second spring, the first spring being an over center spring and the second spring being a retaining spring. At least the position of the pivot point of the over center spring and either the spring constant or the spring travel or both the spring constant and the spring travel of the retaining spring are adjustable.

This embodiment may for example be implemented by an over center spring, whose one end is fixed to a perforated plate or to a slot to permit the pivot point to be changed, and a retaining spring contained in a cartouche to permit it to be exchanged easily for a spring with a different spring characteristic.

For the retaining spring and the over center spring and, if necessary, other springs, springs of different materials, with different stiffnesses and spring constants can be used, whose spring characteristics may be linear or non-linear. It is also possible, to use a combination of several springs for the retaining spring as well as for the over center spring.

With an actuation system according to the invention, it is possible to easily adjust the clutch-by-wire-system according to customer needs. The actuation system is technically not more complex than that of a conventional clutch-by-wire-system, because the adjustment of the spring characteristic is carried out by manually changing the spring or its position. It thus has to be ensured that the springs are accessible and easily changeable.

According to an embodiment of the invention, a method for customizing an actuation system for a clutch-by-wire system includes adjusting the spring characteristic of at least one spring providing a load, against which a clutch pedal of the clutch-by-wire system is movable.

The spring characteristic may be adjusted by exchanging the spring and/or by changing the spring travel and/or by changing the pre-load of the spring and/or by changing the position of a pivot point of the spring.

The pivot point may be changed by loosening a fastening of the spring in the pivot point, choosing a different position for the pivot point and fastening the spring in the different position.

### BRIEF DESCRIPTION OF THE DRAWINGS

The present invention will hereinafter be described in conjunction with the following drawing figures, wherein like numerals denote like elements, and:

FIG. 1 shows a diagrammatic view of an actuation system for a clutch-by-wire system according to prior art;

FIG. 2 shows a diagrammatic view of a part of an actuation system for a clutch-by-wire system according to an embodiment of the present invention;

FIG. 3 shows a diagrammatic view of a part of an actuation system for a clutch-by-wire system according to another embodiment of the present invention;

FIG. 4 shows a diagrammatic view of a part of an actuation system for a clutch-by-wire system according to another embodiment of the present invention; and

FIG. 5 shows a diagrammatic view of a part of an actuation system for a clutch-by-wire system according to another embodiment of the present invention.

### DETAILED DESCRIPTION

The following detailed description is merely exemplary in nature and is not intended to limit application and uses. Furthermore, there is no intention to be bound by any theory presented in the preceding background or summary or the following detailed description.

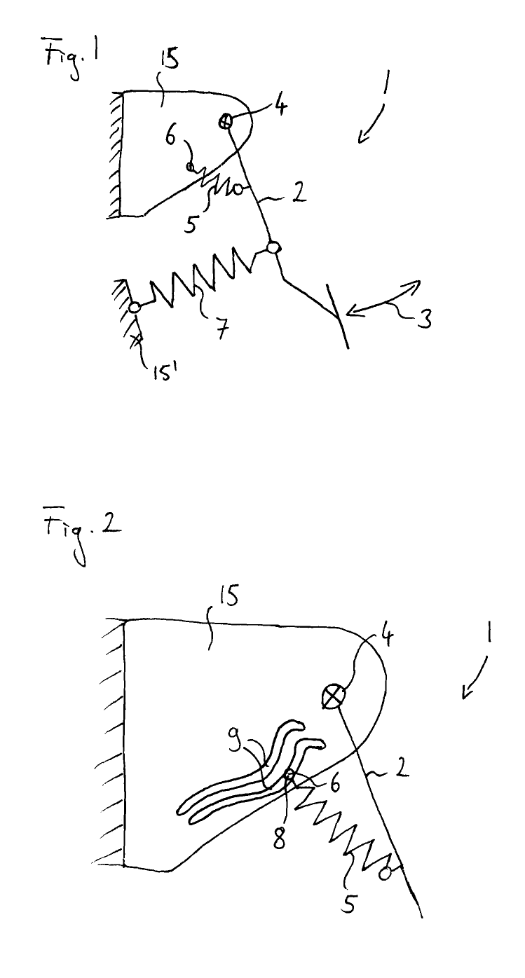

FIG. 1 illustrates the functional principle of an actuation system 1 for a clutch-by-wire system of a vehicle. The actuation system 1 comprises a clutch pedal 2 movable in the directions indicated by the arrow 3. One end of the clutch pedal 2 is fastened to a vehicle part 15.

The actuation system 1 further comprises a retaining spring 7 providing a load, against which the clutch pedal 2 is movable. One end of the retaining spring 7 is fastened to a vehicle part 15′, the other to the clutch pedal 2.

The actuation system 1 further comprises another spring, the over center spring 5. The over center spring 5 is fastened pivotably on the vehicle part 15 with a pivot point 6.

The actuation system 1 further comprises a position sensor 4, which picks up the position of the clutch pedal 2 for example by measuring rotation or translation or the clutch pedal 2 and generates an electric signal accordingly.

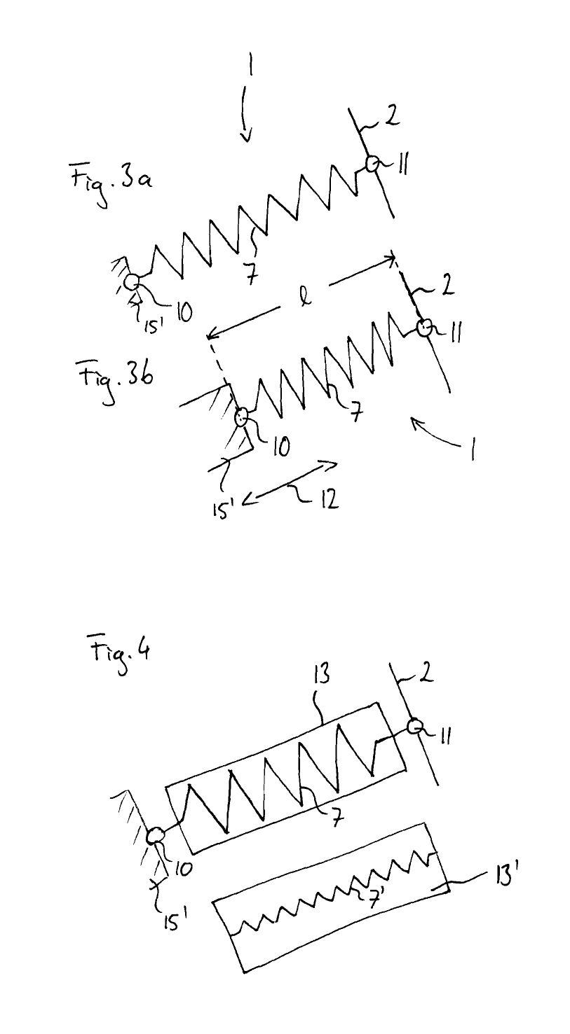

FIG. 2 shows a diagrammatic view of a part of an actuation system 1 for a clutch-by-wire system according to an embodiment of the present invention. According to this embodiment, the spring characteristic of the over center spring 5 can be adjusted to customer needs by changing the position of the pivot point 6.

The vehicle part 15, to which the over center spring 5 is fixed, comprises a number of slots 9, to which one end of the over center spring 5 is fastened pivotably by a fastening element 8, for example a screw or a bolt. The over center spring 5 is fixed in the pivot point 6 by frictional locking. In order to change the position of the pivot point 6, the fastening element 8 is loosened, the end of the over center spring 5 is moved either along the same slot 9 or moved to a different slot 9 until the right position has been found for the new pivot point 6. Then the fastening element 8 is fastened again to fix the over center spring 5 in the new pivot point 6 by frictional locking.

FIG. 3 shows a diagrammatic view of a part of an actuation system 1 for a clutch-by-wire system according to another embodiment of the present invention. According to this embodiment, the spring characteristic of the retaining spring 7 can be adjusted to customer needs by changing the pre-load of the retaining spring 7. In order to change the pre-load, the vehicle part 15′, to which one end of the retaining spring 7 is fixed, is movable in the directions indicated by the arrow 12. The retaining spring 7 can thus be elongated or shortened by changing the distance 1 between a first fixing point 10 and a second fixing point 11 of the retaining spring 7.

FIG. 3a shows the elongated retaining spring 7, while FIG. 3b shows the shortened retaining spring 7.

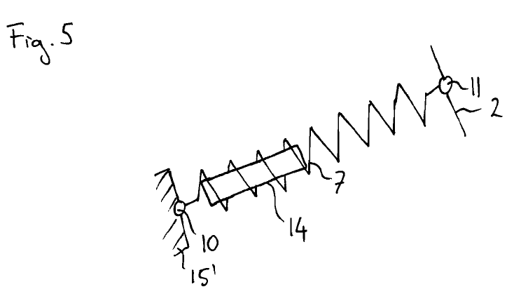

FIG. 4 shows a diagrammatic view of a part of an actuation system 1 for a clutch-by-wire system according to another embodiment of the present invention. According to this embodiment, the retaining spring 7 is contained in a cartouche 13 that allows for easily replacing the whole retaining spring 7 by a retaining spring 7′ with a different spring characteristic.

FIG. 5 shows a diagrammatic view of a part of an actuation system 1 for a clutch-by-wire system according to an embodiment of the present invention. According to this embodiment, the spring travel of the retaining spring 7 is changed by inserting a bolting element 14, which disables a part of the spring travel.

Features of the embodiments shown in FIG. 2 to FIG. 5 may be combined with each other. In particular, changes shown for the retaining spring 7, 7′ may also be implemented for the over center spring 5 and vice versa.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. An actuation system for a clutch-by-wire system, comprising:
a clutch pedal;
a position sensor configured to sense an actual position of the clutch pedal and provide a position signal; and
a spring configured to provide a load against which the clutch pedal is movable,
wherein
a spring characteristic of the spring is adjustable.

2. The actuation system according to claim 1,
wherein
the spring characteristic is adjustable by exchanging the spring.

3. The actuation system according to claim 2,
wherein
the spring is contained in an exchangeable cartouche.

4. The actuation system according to any of claim 1,
wherein
the spring characteristic is adjustable by changing a travel of the spring.

5. The actuation system according to claim 4,
wherein
the travel is reduced by inserting a bolting element that disables a part of the travel.

6. The actuation system according to any of claim 1,
wherein
the spring characteristic is adjustable by changing a position of a pivot point of the spring.

7. The actuation system according to claim 6,
wherein
the spring is fixed in the pivot point by a frictional locking.

8. The actuation system according to claim 7,
wherein
a finite number of pivot points is provided by a perforated plate in whose perforations the spring is fixed by a fastening element.

9. The actuation system according to claim 7,
wherein
a number of pivot points are provided by at least one slot, in which the spring is fixed by a fastening element.

10. The actuation system according to any of claim 1,
wherein
the spring characteristic is adjustable by changing a pre-load of the spring.

11. The actuation system according to claim 1,
further comprising a first spring and a second spring, the first spring configured as an over center spring and the second spring configured as a retaining spring,
wherein
the position of the pivot point of the over center spring, and
either the spring constant or the spring travel or both the spring constant and the spring travel of the retaining spring
are adjustable.

12. A method for customizing an actuation system for a clutch-by-wire system, comprising:
providing a load with a spring characteristic of a spring against which a clutch pedal of the clutch-by-wire system is movable; and
adjusting the spring characteristic of the spring.

13. The method according to claim 12,
wherein the adjusting the spring characteristic of the spring comprising
exchanging the spring.

14. The method according to claim 12,
wherein the adjusting the spring characteristic of the spring comprises
changing the position of a pivot point of the spring.

15. The method according to claim 14,
wherein the changing the position of the pivot point of the spring comprises:
loosening a fastening of the spring in the pivot point;
choosing a different position for the pivot point; and
fastening the spring in the different position.
